(19) United States
(12) Patent Application Publication
(10) Pub. No.: US 2009/0069990 A1
(43) Pub. Date: Mar. 12, 2009

(54) PROCEDURE AND COMPUTER PROGRAM FOR FEEDBACK CONTROL OF A DRIVE

(75) Inventors: Martin Behm, Ulm (DE); Karlheinz Vogl, Ummendorf (DE)

Correspondence Address: SCULLY SCOTT MURPHY & PRESSER, PC, 400 GARDEN CITY PLAZA, SUITE 300, GARDEN CITY, NY, 11530, US

(73) Assignee: BRUENINGHAUS HYDROMATIK GMBH, Elchingen (DE)

(21) Appl. No.: 12/297,583

(22) PCT Filed: Apr. 5, 2007
(86) PCT No.: PCT/EP2007/003110

§ 371 Date: Oct. 17, 2008

(30) Foreign Application Priority Data
Apr. 18, 2006 (DE) 10 2006 017 792.4

(51) Int. Cl. B60W 10/04

(52) U.S. Cl. 701/55

(57) ABSTRACT

The invention relates to a method for regulating a drive (1) having a drive machine (2) and a hydrostatic gearing (3) with an adjustable hydraulic pump (4) and an adjustable hydraulic motor (5). The adjustable hydraulic pump and the adjustable hydraulic motor are connected to one another in a hydrostatic circuit. An operating point of the drive machine (2) is initially determined in a characteristic map of the drive machine (2). A transmission ratio (i_{hydr}) of the hydrostatic gearing (3) is additionally defined during the determination of the operating point. An optimum feed volume for the hydraulic pump (4) and an optimum suction volume for the hydraulic motor (5) is determined from said transmission ratio (i_{hydr}).

The invention relates to a procedure and a computer program for feedback control of a drive which comprises a driving engine and a hydrostatic transmission.

Drives in which a hydrostatic transmission is driven by a driving engine are frequently used in the case of utility vehicles such as, for example, excavators or wheeled loaders. Such drive systems are used, for example, for controlling the slewing mechanism or as a travelling drive. Usually, in the case of such drives, a rotational speed value is predefined for the diesel engine. The engine control system then converts the rotational speed on the part of the driving engine. Known from DE 196 43 924 A1 for this purpose is the practice of improving the precision with which the rotational speed of the diesel engine is maintained. For this purpose, a rotational-speed reference value of the engine control system is compared with an actual rotational speed value, and a correction value derived therefrom is calculated. The correction value is output to a stepper motor, which repositions the actuator and thereby corrects the actual rotational speed of the diesel engine. Such simple feedback control systems have the disadvantage that neither the hydrostatic transmission nor the control system of the diesel engine takes account of the efficiency profile. In particular, losses in the lines of the hydrostatic circuit are also disregarded.

The object of the invention is to create a procedure for feedback control of a drive in which the total efficiency is improved.

The object is achieved by the features of claim 1. The other claims relate to advantageous refinements of the invention and to a digital storage medium and a computer program with the procedure according to the invention.

In the case of the procedure, according to the invention, for feedback control of a drive which comprises a driving engine and a hydrostatic transmission, an operating point of the driving engine is firstly determined in a characteristics map of the driving engine. In addition, a transmission ratio of the hydrostatic transmission is determined. According to the invention, an optimum displacement volume of the hydraulic pump and an optimum absorption volume of the hydraulic motor are determined for the determined transmission ratio. The procedure according to the invention is based on the knowledge that, in the case of a predetermined transmission ratio of the hydrostatic transmission, differing settings of the hydraulic pump and of the hydraulic motor are possible for the purpose of achieving this predetermined transmission ratio, and these differing settings result in differing efficiencies on the part of the hydrostatic transmission. Consequently, whilst maintaining the predetermined transmission ratio, it is sought to determine that operating point of the hydrostatic transmission which renders possible optimum efficiency.

The use of the term “optimum” in connection with the displacement volume and absorption volume to be determined and the efficiencies to be subsequently set includes such operating points that do not correspond to the maximum of the respective value. In this case, for example, account may be taken of operating states which make setting of the maximum value appear unfavourable. For example, it may be necessary for the operating point of an axial piston engine to be outside the operating point that is most favourable economically, for instance in order to achieve improved cooling, and therefore necessary to set a greater displacement volume and absorption volume in respect of efficiency.

Advantageous refinements of the procedure according to the invention are stated in the sub-claims. In particular, it is advantageous for the operating point of the driving engine to be determined on the basis of a predefined idling speed, by determining a deviation between the predetermined idling speed and an actual rotational speed. This deviation, which is also termed slip, is preferably predetermined for each predefined idling speed.

There is preferably stored in a control unit of the hydrostatic transmission at least one efficiency table which is taken into account in the determination of the optimum displacement volume of the hydraulic pump and of the optimum absorption volume of the hydraulic motor.

Furthermore, it is advantageous to take account of the actual pressure loss in the lines. For this purpose, at least a first pressure value and a second pressure value are measured in the hydraulic circuit, and a pressure difference is calculated. This pressure difference is taken into account in the determination of the optimum absorption volume and of the optimum displacement volume.

It is additionally advantageous to determine the transmission ratio of the hydrostatic transmission in dependence on the slip, i.e. on the deviation of the actual rotational speed from a predefined idling rotational speed of the driving engine. It is furthermore advantageous, on the basis of this transmission ratio, to determine an optimum displacement volume and an optimum absorption volume with the line pressure loss being taken into account.

In particular, it is advantageous in this case to determine the optimum absorption volume and the optimum displacement volume with the mechanical-hydraulic efficiency of the hydraulic pump and hydraulic motor being taken into account. It is furthermore particularly advantageous if the volumetric efficiency of the hydraulic pump and of the hydraulic motor is taken into account. According to a particularly advantageous embodiment, both the mechanical-hydraulic efficiency and the volumetric efficiency and, in addition, the line pressure loss in the hydraulic circuit, are taken into account in the determination of the optimum absorption volume and optimum displacement volume in the case of a predefined transmission ratio. Since the efficiency profiles are in part mutually compensating over the wide potential setting range of the displacement volume and absorption volume, it is thus possible to set an improved efficiency of the hydrostatic transmission, in the case of a defined, set transmission ratio, with all three factors that contribute to the efficiency being taken into account. In this way, in the case of travelling drives of utility vehicles, for instance, fuel saving up of to 10% are possible. In the case of an iterative procedure, it may be advantageous, in particular, to check the set idling speed and to correct the actually resultant slip following setting of the displacement volume and absorption volume.

A preferred embodiment of the procedure according to the invention is represented in the drawing and described more fully in the description that follows. In the drawing:

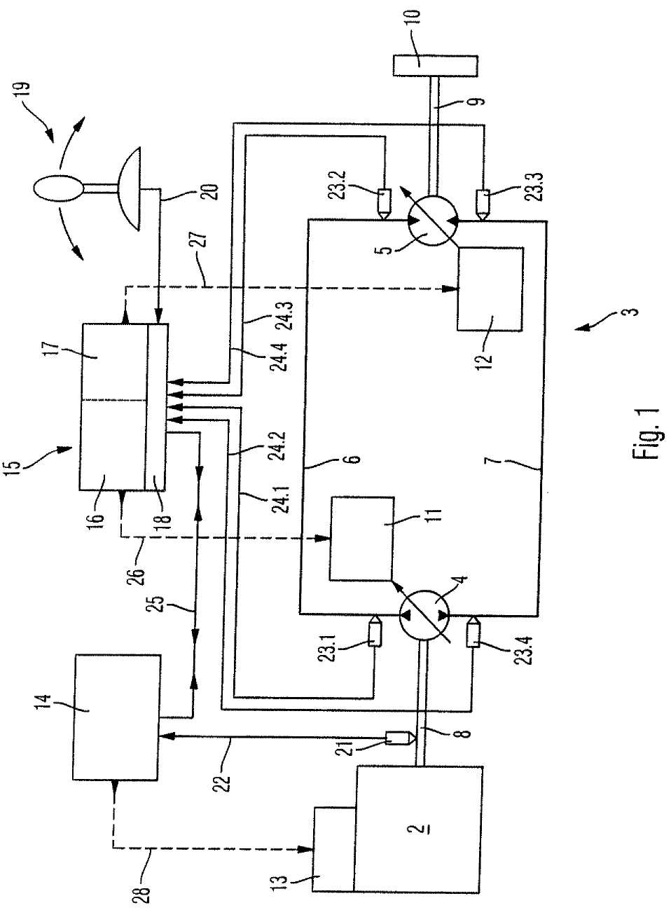

FIG. 1 shows a schematic representation of a drive for realization of the procedure, according to the invention, for feedback control of such a drive;

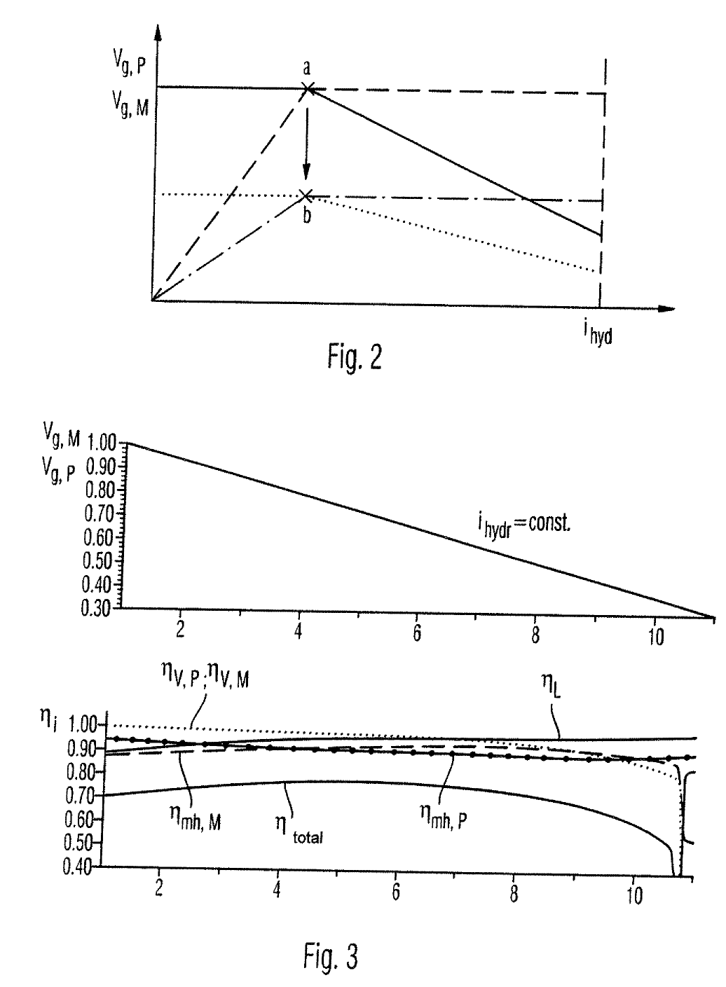

FIG. 2 shows a diagram to explain the setting of a hydraulic transmission ratio;

FIG. 3 shows the profile of efficiencies in the case of a predefined transmission ratio;

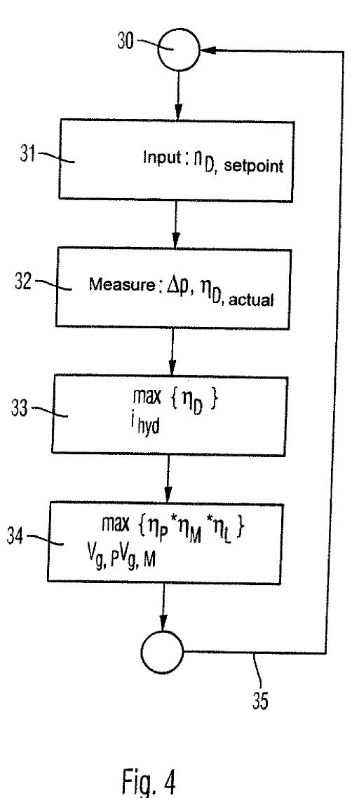

FIG. 4 shows a flow diagram for realization of the procedure according to the invention;

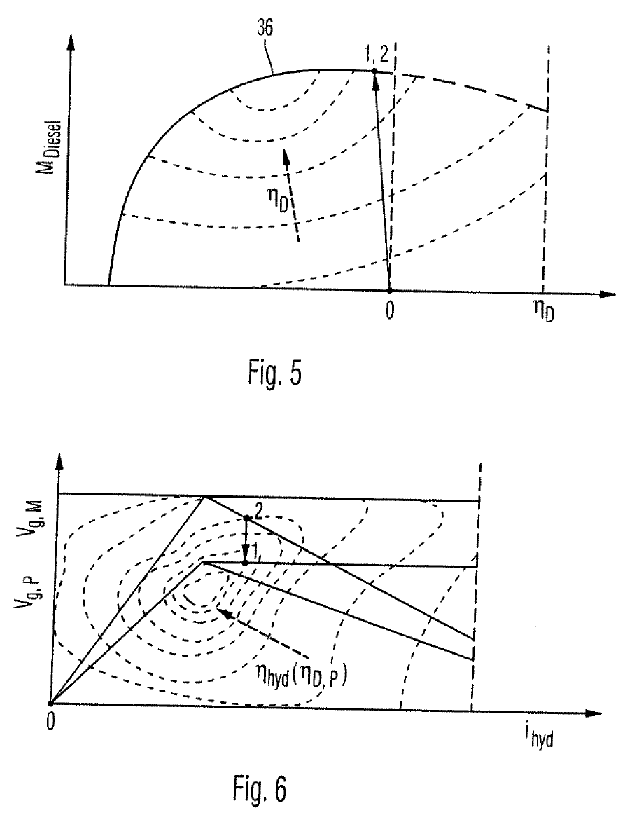

FIG. 5 shows a characteristics map of a diesel internal combustion engine, for determination of the operating point of the driving engine; and

FIG. 6 shows a characteristics map of the hydrostatic transmission, for determination of a displacement volume to be set and of an absorption volume to be set.

To aid understanding, before the procedure according to the invention is described in detail there follows firstly an explanation of the structure of a drive, in particular that of a travelling drive, with reference to FIG. 1.

FIG. 1 shows a drive 1, in which a hydrostatic transmission 3 is driven by means of a driving engine which, in the case of the exemplary embodiment represented, is realized as a diesel internal combustion engine 2. The hydrostatic transmission 3 comprises a settable hydraulic pump 4 and a settable hydraulic motor 5. The hydraulic pump 4 and the hydraulic motor 5 are connected to each other in a closed hydraulic circuit via a first working line 6 and a second working line 7.

The diesel internal combustion engine 2 generates a drive torque at a driving shaft 8. The diesel internal combustion engine 2 is connected to the hydraulic pump 4 via the driving shaft 8, such that the hydraulic pump 4 is driven by the torque generated by the diesel internal combustion engine 2. Depending on the set displacement volume of the hydraulic pump 4, pressure medium is delivered by the hydraulic pump 4 into either the first working line 6 or the second working line 7. An output torque is thus generated in the closed hydraulic circuit in dependence on the set absorption volume. The output torque is transmitted by the hydraulic motor 5 to, for example, a driven wheel 10, via an output shaft 9. For reasons of clarity, in the case of the exemplary embodiment represented, direct driving of a driven vehicle wheel 10 by the hydraulic motor 5 is illustrated. However, it is also possible, for instance, for a powershift transmission to be connected on the output side of the hydrostatic drive.

A pump adjusting device 11 is provided for setting the displacement volume of the hydraulic pump 4, and a motor adjusting device 12 is provided for setting the absorption volume of the hydraulic motor 5. The pump adjusting device 11 and the motor adjusting device 12 cooperate with an adjusting mechanism of, respectively, the hydraulic pump 4 and the hydraulic motor 5. In the case of the exemplary embodiment represented, both the hydraulic pump 4 and the hydraulic motor 5 are adjustable in both directions, starting from a neutral position. The hydraulic pump 4 and the hydraulic motor 5 are preferably axial piston engines of the swash-plate type.

For the purpose of setting an operating point of the diesel internal combustion engine 2, a first control device 14 predefines a delivery rate for an injection pump 13. For this, a corresponding signal is transmitted from the first control device 14 to the injection pump 13 via a first signal line 28.

The hydrostatic transmission 3 is set by means of at least one second control device 15. In the case of the exemplary embodiment represented, the second control device 15 comprises a first control unit 16 and a second control unit 17. It is also possible, however, for two separate control devices to be provided, assigned respectively to the hydraulic pump 4 and to the hydraulic motor 5. In the case of the exemplary embodiment represented, an integrated design is preferred, in which the first control unit 16 is assigned to the hydraulic pump 4 and the second control unit 17 is assigned to the hydraulic motor 5. Accordingly, a control signal is transmitted by the first control unit 16 to the pump adjusting device 11. The second control unit 17 transmits a corresponding control signal to the motor adjusting device 12. It is particularly preferred if the pump adjusting device 11 and the motor adjusting device 12 are of an electro-proportional design. In that case, not represented, control valves generate actuating pressures which act upon, for instance, an adjusting piston which cooperates with the respective adjusting mechanism.

In the case of the exemplary embodiment represented, the two control units 16, 17 of the second control device 15 have a common interface unit 18. The signals on which the setting of both the hydraulic pump 4 and the hydraulic motor 5 are based are received and output via the common interface unit 18. For example, a signal of a travel control lever 19 is transmitted to the second control device 15, this signal being supplied to the common interface unit 18 via a travel signal line 20. The travel control lever 19 is used by an operator to select a desired direction and speed of travel.

Further input quantities are provided by the signals from pressure sensors 23.1 to 23.4, which determine the respective pressures close to the connections of the hydraulic pump 4 and hydraulic motor 5, and transmit these pressures to the second control device 15 via respective pressure signal lines 24.1 to 24.4. The pressure values supplied by the pressure sensors 23.1 to 23.4 are then used to determine the pressure drop within the working lines 6, 7 of the hydrostatic transmission 3. This pressure drop has to be taken into account in determination of the displacement volume of the hydraulic pump 4 to be set and in determination of the absorption volume of the hydraulic motor 5 to be set, since it is included, in a manner to be explained below, in the total efficiency of the hydrostatic transmission 3.

In addition, the actual rotational speed of the driving shaft 8 is acquired by a rotational-speed sensor 21, the signal from which is transmitted to the first control device 14 via a rotational-speed signal line 22.

The first control device 14 and the second control device 15 are connected to each other via a communication line 25. Thus, the second control device 15 predefines an idling speed and transmits it to the first control device 14 via the communication line 25. Via the first signal line 28, the first control device 14 transmits a signal to the injection pump 13, and sets the diesel internal combustion engine 2 to this predefined idling speed. Owing to the load taken off by the hydrostatic transmission 3, the actual rotation speed of the diesel internal combustion engine 2 comes to deviate from the predefined idling speed. The predefined idling speed is preferably determined by the second control device 15, in that there is defined a rotational speed of the diesel internal combustion engine 2 at which the travel selection of a user, made via the travel control lever 19, can be realized.

In the first control device 14, a difference is now calculated between the predefined idling speed and the actual rotational speed determined by the rotational-speed sensor 21, and this so-called slip is preferably transmitted to the second control device 15 via the communication line 25. A table in which a slip value is assigned to a predefined idling speed is stored in the second control device 15. This table is applied in dependence on a characteristics map of the diesel internal combustion engine 2, such that one favourable actual rotational speed is stored for respectively one predefined idling speed. In order to achieve this actual rotational speed, or a defined slip, the transmission ratio i_{hydr} of the hydrostatic transmission 2 is adapted accordingly. Consequently, the second control device 15 determines a transmission ratio i_{hydr} for the hydrostatic transmission.

To define the optimum operating point of the hydrostatic transmission, it is necessary to set both the displacement volume of the hydraulic pump and the displacement volume of the hydraulic pump 5. The hydraulic pump 4 is set to its optimum displacement volume and the hydraulic motor 5 is set to its optimum absorption volume, with the volumetric efficiency ηᵥ and the pressure loss ηₚ in the lines preferably also being taken into account in addition to the mechanical-hydraulic efficiencies ηₘₕ of the two piston engines. The efficiency profiles are preferably stored in tables in the second control device. Starting from the initially determined transmission ratio i_{hydr} of the hydrostatic transmission 3, and taking account of the pressure losses in the working lines 6, 7 of the hydrostatic transmission 3 calculated from the values of the pressure sensors 23.1 to 23.4, in the case of swash-plate type engines being used the first control unit 16 and the second control unit 17 determine the swivel angle of the swash plate, and a corresponding value is transmitted to the pump adjusting device 11 via a second signal line 26, and to the motor adjusting device 12 via a third signal line 27.

FIG. 2 illustrates the relationship between the set displacement and absorption volumes for a fixed transmission ratio of the hydrostatic transmission 3. A constant transmission ratio i_{hydr} of the hydrostatic transmission 3 is obtained both for a large displacement volume through the hydraulic pump, with a simultaneously high absorption volume of the hydraulic motor 5, and in the case of a small displacement volume through the hydraulic pump 4, with a simultaneously small absorption volume of the hydraulic motor 5. However, since differing volumetric efficiencies and also differing mechanical-hydraulic efficiencies are obtained for the differing swivel angle settings of the hydraulic pump 4 and hydraulic motor 5, optimization of the total efficiency ηₜₒₜₐₗ can be achieved whilst maintaining a defined transmission ratio i_{hydr}. In this case it is to be taken into account, in particular, that the mechanical-hydraulic efficiencies and the volumetric efficiency compensate each other in part over the adjustment range. In contrast thereto, the line loss in the working lines 6, 7 increases monotonically as a function of increasing volume flow in the lines.

FIG. 2 shows, by way of example, a first operating point a with maximum displacement volume V_{g,p} of the hydraulic pump 4 and maximum absorption volume V_{g,M} of the hydraulic motor 5 and, in the case of an identical transmission ratio i_{hydr}, an optimum displacement volume and absorption volume at the operating point b.

The relationships between the efficiency contributions and the total efficiency ηₜₒₜₐₗ are illustrated in FIG. 3. The upper diagram shows that, for a fixedly predefined transmission ratio i_{hydr}, the set displacement volume of the hydraulic pump 4 and the set absorption volume of the hydraulic motor 5 are reduced continuously, starting from the maximum value at V_{g,M}, V_{g,p}=1. Obtained therefrom are the efficiency profiles shown in the lower representation. This representation shows the individual efficiency contributions ηᵢ that contribute to the total efficiency ηₜₒₜₐₗ, assuming a constant transmission ratio i_{hydr} and a constant load. The abscissa is scaled with arbitrary units, and shows the progression in the direction of increasing pressure, i.e. simultaneously decreasing volume flow, in the working lines 6, 7.

It is therefore good to see that the efficiency profile η_{L} caused by the pressure loss in the lines rises steadily as the displacement volume decreases.

At the same time, the volumetric efficiency η_{V,P} and η_{V,M} of the pump and motor declines as pressure increases, i.e. as displacement volume decreases. Up to a certain point, however, this is compensated by the simultaneous improvement in the mechanical-hydraulic efficiency η_{mh,M} and η_{mh,P}. Thus, for a defined load, in the case of a defined transmission ratio i_{hydr}, the represented profile is obtained for the total efficiency ηₜₒₜₐₗ of the hydrostatic transmission 3.

In FIG. 4, the procedure according to the invention is represented in a simplified flow diagram. Following the start of the programme (step 30), an idling speed η_{D,setpoint} is firstly input for the diesel internal combustion engine 2 (step 31). In addition, the results of the pressure sensors 23.1 to 23.4 are input by the second control device 15, and from these is calculated the pressure drop Δp in the working lines 6, 7. In addition, the measurement result of the rotational-speed sensor 21 is transmitted to the second control device 15 via the first control device 14 and the communication line 25 (step 32). On the basis of this information, in step 33 the optimum operating point of the diesel internal combustion engine 2 is then first determined with the aid of the characteristics map of the diesel internal combustion engine 2. For this, the data describing the characteristics map of the diesel internal combustion engine 2 are stored in a corresponding table in the second electronic control device 15. The transmission ratio i_{hydr} is determined in the second control device 15.

Finally, in step 34, the efficiency of the hydrostatic transmission 3 is optimized, in that the respectively optimum displacement volume is determined for the hydraulic pump, and the respectively optimum absorption volume is determined for the hydraulic motor 5, with account being taken of the individual influencing factors, namely, the individual efficiency of both the hydraulic pump 4 and the hydraulic motor 5 and, in addition, of the line losses for the determined transmission ratio i_{hydr}. The thus determined values are transmitted, in the manner described previously, to the pump adjusting device 11 and to the motor adjusting device 12 via the second and the third signal line 26, 27. At the end of this setting operation, there is a jump back to the start of the procedure (35).

The procedure in respect of the diesel internal combustion engine 2 is shown yet again in FIG. 5 (corresponding to step 33). FIG. 5 shows a simplified characteristics map of a diesel internal combustion engine 2. The idling speed is denoted by the point 0. The deviation of the actual rotational speed at the point 1, 2 from the predefined idling speed is termed slip, and is directly related to the transmission ratio of the hydrostatic transmission 3. The idling speed is preferably determined on the basis of a position of the drive control lever 19, and is thus adapted to the anticipated amount of power to be taken off. In the example represented, the operating point is located on the full-load line 36.

The subsequent procedure (step 34) is represented yet again in FIG. 6. The transmission ratio i_{hydr} is entered on the abscissa. The broken lines indicate the sum of the operating states having an identical efficiency η_{hydr}. Since the components that influence the efficiency of the hydrostatic transmission are taken into account, in the diagram activation is effected at the operating point 2, instead of at the operating point 1. This is effected, without alteration of the transmission ratio i_{hydr} of the hydrostatic transmission 3, solely through appropriate adaptation of both the displacement volume and, simultaneously, of the absorption volume of the hydraulic pump 4 and hydraulic motor 5.

The invention is not limited to the exemplary embodiment represented. Rather, individual features of the procedure according to the invention can also be combined with other features in a discretionary manner.

1. Procedure for feedback control of a drive which comprises a driving engine and a hydrostatic transmission with a settable hydraulic pump and a settable hydraulic motor which are connected to each other in a hydrostatic circuit, said procedure comprising the following procedural steps:
determination of an operating point of the driving engine in a characteristics map of the driving engine
determination of a transmission ratio (i_{hydr}) of the hydrostatic transmission
determination of an optimum displacement volume of the hydraulic pump and of an optimum absorption volume of the hydraulic motor for the purpose of setting the determined transmission ratio (i_{hydr}), with the efficiencies (η_{mh,P}, η_{V,P}; η_{mh,M, η}_{V,M}) of the hydraulic pump and of the hydraulic motor and an efficiency ηᵥ) of the hydrostatic circuit being taken into account.

2. Procedure according to claim 1, wherein
for the purpose of determining the operating point of the driving machine, an idling speed is defined and the quantity of a deviation of the actual rotational speed from the predefined idling speed is determined.

3. Procedure according to claim 2, wherein
one predefined deviation of the actual rotational speed from the predefined idling speed is assigned respectively to one predefined idling speed.

4. Procedure according to claim 1, wherein
at least one efficiency table is stored in a control unit of the hydrostatic transmission.

5. Procedure according to claim 1, wherein
a pressure difference (sp) is measured in the hydraulic circuit.

6. Method according to claim 1, wherein
the determination of the transmission ratio (i_{hydr}) of the hydrostatic transmission is effected in dependence on a deviation of the actual rotational speed from a predefined idling speed.

7. Procedure according to claim 6, wherein
for a determined transmission ratio (i_{hydr}), an optimized displacement volume and an optimized absorption volume are determined, with a line pressure loss (sp) being taken into account.

8. Procedure according to claim 6, wherein
for a determined transmission ratio (i_{hydr}), an optimized displacement volume and an optimized absorption volume are determined, with mechanical-hydraulic efficiencies (η_{mh,P}; η_{mh,M})of the hydraulic pump and of the hydraulic motor being taken into account.

9. Procedure according to claim 6, wherein for a determined transmission ratio (i_{hydr}), an optimized displacement volume and an optimized absorption volume are determined, with volumetric efficiencies (η_{V,P}; η_{V,M}) of the hydraulic pump and of the hydraulic motor being taken into account.

10. Procedure according to claim 1, wherein
the drive comprises a first control device for the driving engine and at least one second control device for the hydrostatic transmission, and the at least one second control device predefines the idling speed for the first control device.

11. Procedure according to claim 10, wherein
the idling speed is determined in dependence on a power requirement.

12. Digital storage medium with electronically readable control signals which can be cooperated with a programmable computer or digital signal processor such that the procedure according to claim 1 is executed.

13. Computer program having programme code means for performing all steps according to claim 1 when the program is executed on a computer or digital control processor.
